(19) United States
(12) Patent Application Publication
(10) Pub. No.: US 2012/0020233 A1
(43) Pub. Date: Jan. 26, 2012

(54) APPARATUS AND METHOD FOR RECEIVING DATA IN A COMMUNICATION SYSTEM

(75) Inventors: Seung-Wook LEE, Daejeon (KR); Bon-Ki Koo, Daejeon (KR); Ho-Won Kim, Seoul (KR); Chang-Woo Chu, Daejeon (KR); Ji-Hyung Lee, Daejeon (KR); Euee-Seon Jang, Seoul (KR); Hyun-Gyu Kim, Seoul (KR); Min-Soo Park, Seoul (KR); So-Won Kim, Seoul (KR); Tae-Hee Lim, Seoul (KR)

(73) Assignees: Industry-University Cooperation Foundation Hanyang University, Seoul (KR); Electronics and Telecommunications Research Institute, Daejeon (KR)

(21) Appl. No.: 13/186,903

(22) Filed: Jul. 20, 2011

(30) Foreign Application Priority Data
Jul. 21, 2010 (KR) 10-2010-0070411
Jul. 14, 2011 (KR) 10-2011-0069941

(51) Int. Cl. H04L 12/26

(52) U.S. Cl. 370/252

(57) ABSTRACT

An apparatus for receiving data in a communication system includes a parser configured to receive multimedia data and analyze the multimedia data into a plurality of tokens; a plurality of decoding units configured to receive input tokens corresponding to them among the plurality of tokens and decode the multimedia data; and a scheduler configured to schedule the plurality of tokens and transmit the respective input tokens to the plurality of decoding units at precise times, wherein the plurality of decoding units decode the multimedia data by the input tokens transmitted from the scheduler and provide a multimedia service.

### CROSS-REFERENCES TO RELATED APPLICATIONS

The present application claims priority of Korean Patent Application Nos. 10-2010-0070411 and 10-2011-0069941, filed on Jul. 21, 2010 and Jul. 14, 2011, respectively, which are incorporated herein by reference in their entireties.

### BACKGROUND OF THE INVENTION

1. Field of the Invention

Exemplary embodiments of the present invention relate to a communication system, and, more particularly, to an apparatus and a method for receiving data by decoding multimedia data through a plurality of decoding units modularized in a network codec system.

2. Description of Related Art

In a current communication system, research for providing services having various quality of service (hereinafter, referred to as ‘QoS’) to users at a high transmission speed has been actively conducted. In an MPEG (moving picture experts group)-based system as an example of such a communication system, research for providing a method for transmitting stably and at a high speed large-capacity multimedia data such as audio, video and the like through a limited resource has been actively conducted.

Also, in an MPEG-based network codec system, research for providing a method for transmitting and receiving large-capacity multimedia data through a plurality of encoding and decoding units having predetermined encoding and decoding algorithms realized therein and modularized thereby has been conducted. In particular, recently, a method has been suggested, in which data are transmitted and received by encoding and decoding large-capaicity multimedia data through realizing a plurality of encoding and decoding units for respective predetermined encoding and decoding algorithms and implementing data transmission among the encoding and decoding units realized in this way.

However, in a current communication system, in order to transmit and receive large-capacity multimedia data through a plurality of encoding and decoding units realized for respective encoding and decoding algorithms, precise data transmission among the respective realized encoding and decoding units is necessary. In particular, although data input and output to and from the respective encoding and decoding units should be precisely implemented, a concrete method therefor has not been suggested so far.

In other words, in order for the respective encoding and decoding units to normally execute the encoding and decoding algorithms and transmit and receive the large-capacity multimedia data, only when corresponding input data are precisely inputted to the respective encoding and decoding units at precise times (or in a precise sequence), the respective encoding and decoding units can normally execute the predetermined encoding and decoding algorithms.

Nevertheless, in a current communication system, a concrete method for precisely inputting corresponding input data to the respective encoding and decoding units at precise times (or in a precise sequence) and thereby transmitting and receiving the large-capacity multimedia data has not been disclosed in the art. In particular, in a current MPEG-based network codec system, a method for precisely decoding large-capacity multimedia data received through a limited resource by using a plurality of decoding units does not exist.

Therefore, in a communication system, for example, an MPEG system, in order to receive at a high speed and stably large-capacity multimedia data such as audio, video and the like, a method for receiving data by normally decoding the large-capacity multimedia data through a plurality of decoding units having predetermined decoding algorithms realized therein is demanded in the art.

### SUMMARY OF THE INVENTION

Embodiments of the present invention are directed to an apparatus and a method for receiving data in a communication system.

Other embodiments of the present invention are directed to an apparatus and a method for receiving stably and at a high speed large-capacity multimedia data such as audio, video and the like in a communication system.

Other embodiments of the present invention are directed to an apparatus and a method for receiving data by normally decoding large-capacity multimedia data through a plurality of decoding units having predetermined decoding algorithms respectively realized therein in a communication system.

Other embodiments of the present invention are directed to an apparatus and a method for receiving data in a communication system by precisely inputting corresponding input data at precise times (or in a precise sequence) to a plurality of decoding units having predetermined decoding algorithms respectively realized therein, thereby normally decoding multimedia data.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

In accordance with an embodiment of the present invention, an apparatus for receiving data in a communication system includes: a parser configured to receive multimedia data and analyze the multimedia data into a plurality of tokens; a plurality of decoding units configured to receive input tokens corresponding to them among the plurality of tokens and decode the multimedia data; and a scheduler configured to schedule the plurality of tokens and transmit the respective input tokens to the plurality of decoding units at precise times, wherein the plurality of decoding units decode the multimedia data by the input tokens transmitted from the scheduler and provide a multimedia service.

In accordance with another embodiment of the present invention, a method for receiving data in a communication system includes: receiving multimedia data, parsing encoded bitstreams of the multimedia data, and analyzing the multimedia data into a plurality of tokens; scheduling the plurality of tokens into respective input tokens corresponding to predetermined decoding algorithms; and executing the respective predetermined decoding algorithms for the input tokens and decoding the multimedia data, wherein, in the scheduling, the respective input tokens are inputted at precise times to the predetermined decoding algorithms respectively corresponding to the input tokens.

### BRIEF DESCRIPTION OF THE DRAWINGS

FIG. 1 is a diagram schematically showing the configuration of an apparatus for receiving data in a communication system in accordance with an embodiment of the present invention.

FIG. 2 is a diagram schematically showing the configuration of an apparatus for receiving data in a communication system in accordance with another embodiment of the present invention.

FIG. 3 is a diagram explaining input and output of tokens in the apparatuses for receiving data in a communication system in accordance with the embodiments of the present invention.

FIG. 4 is a flow chart schematically explaining operations of the apparatus for receiving data in a communication system in accordance with the embodiments of the present invention.

### DESCRIPTION OF SPECIFIC EMBODIMENTS

Exemplary embodiments of the present invention will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention.

The present invention proposes an apparatus and a method for receiving large-capacity multimedia data such as audio, video and the like in a communication system, for example, an MPEG (moving picture experts group)-based system. In embodiments of the present invention, there are proposed an apparatus and a method for receiving data by decoding multimedia data through a plurality of decoding units having predetermined decoding algorithms realized therein in an MPEG-based system, for instance, an MPEG-based network codec system. While the MPEG-based system will be exemplarily described in the embodiments of the present invention, it is to be noted that the data reception scheme as proposed by the present invention may be applied to other communication systems.

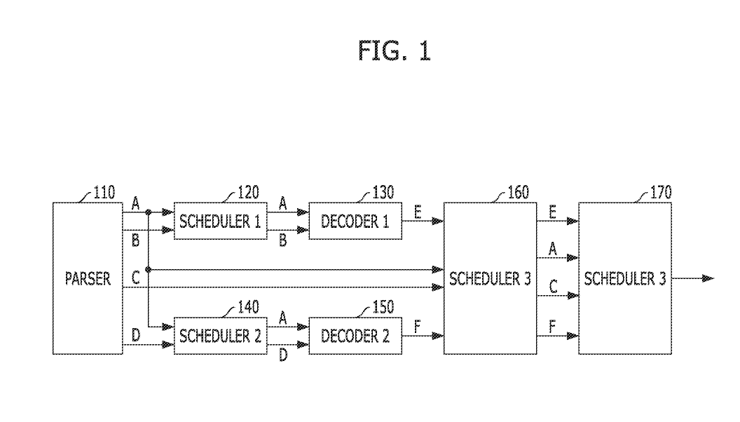

Also, in the embodiments of the present invention, an apparatus and a method for receiving data are proposed for an MPEG-based system which realizes an audio and video codec by using information processing modules performing decoding through predetermined decoding algorithms in a communication system, for example, a plurality of functional units (hereinafter, referred to as ‘FUs’), and an MPEG system which realizes a 3D graphic codec using the audio and video codec, that is, an MPEG RVC (reconfigurable video coding)/RGC (reconfigurable graphics coding) framework. Here, the RVC/RGC framework supports to realize one complete codec system from one or more decoding units, that is, one or more FUs. The respective FUs have inherent inputs and outputs, or a network is formed by the plurality of FUs by connecting the inputs and outputs of the respective FUs and a codec system is realized through data transmission among the respective FUs in the network. Hereinbelow, an apparatus for receiving data in a communication system in accordance with an embodiment of the present invention will be described in detail with reference to FIG. 1.

FIG. 1 is a diagram schematically showing the configuration of an apparatus for receiving data in a communication system in accordance with an embodiment of the present invention. FIG. 1 is a drawing schematically showing the configuration of a data reception apparatus for receiving and decoding large-capacity multimedia data such as audio, video and the like in a communication system, for example, an MPEG-based network codec system, in accordance with an embodiment of the present invention.

Referring to FIG. 1, the data reception apparatus includes a parser 110 configured to receive large-capacity multimedia data such as audio, video and the like, decoders, for example, a decoder 1 130, a decoder 2 150 and a decoder 3 170, configured to decode the large-capacity multimedia data, and schedulers, for example, a scheduler 1 120, a scheduler 2 140 and a scheduler 3 160, configured to schedule the multimedia data to be inputted to the decoders 130, 150 and 170 to be decoded.

The parser 110 receives the large-capacity multimedia data which are encoded and transmitted by a transmission apparatus of the communication system, and analyzes the encoded bitstreams of the received multimedia data into individual data capable of being processed by the respective decoders 130, 150 and 170, for example, into tokens. Here, the parser 110 is realized by one or more syntax parser FUs as one or more exemplary FUs for analyzing the bitstreams of the received multimedia data and outputting a plurality of tokens. The syntax parser FUs may be provided as already completed FUs like other FUs, for example, decoding units, or may be provided when actually realizing a codec system based on BSD (bitstream syntax description) information.

The BSD is information which is included in decoder description information and means information which indicates the bitstream structure of the multimedia data to be decoded by the decoders 130, 150 and 170. Since the decoder description information will be concretely explained below, detailed explanation thereof will be omitted herein. The tokens mean data which are to be inputted to the decoders 130, 150 and 170 to allow the decoders 130, 150 and 170 to decode the large-capacity multimedia data, so as to receive data by decoding the large-capacity multimedia data through a plurality of decoding units as the plurality of FUs having predetermined decoding algorithms realized therein, that is, the decoders 130, 150 and 170. Input data, that is, input tokens are inputted to the decoders 130, 150 and 170 so that decoding can be normally implemented according to the decoding algorithms of the respective decoders 130, 150 and 170.

Also, after analyzing the encoded bitstreams of the received multimedia data into the tokens as the individual data capable of being processed by the respective decoders 130, 150 and 170, the parser 110 outputs the respective analyzed tokens, for example, a token A, a token B, a token C and a token D. The token A, the token B, the token C and the token D are outputted independently of one another according to the data processing capability of the parser 110.

The decoders 130, 150 and 170 serve as FUs being information processing modules having the predetermined decoding algorithms realized therein, that is, as decoding units. When input data necessary for the execution of the decoding algorithms realized in the respective decoders 130, 150 and 170, that is, the tokens corresponding to the respective decoders 130, 150 and 170 are respectively inputted, the decoders 130, 150 and 170 execute the decoding algorithms and decode the large-capacity multimedia data. Here, the decoders 130, 150 and 170 are determined in their connection relationships according to a tool box used in a video codec, that is, a VTL (video tool library), and a tool box used in a graphic codec, that is, a GTL (graphics tool library), among libraries of a plurality of FUs for realizing codecs in an MPEG-based network codec system. In other words, depending upon a service type to be provided to users through decoding of the multimedia data, the connection relationships of the decoders 130, 150 and 170, that is, FND (FU network description) is determined.

The FND as decoder description information means information which indicates the connection relationships of the decoding units as the FUs for decoding the multimedia data, that is, the decoders 130, 150 and 170. The decoder description information means information which indicates the realization of decoders using an RVC/RGC platform in the MPEG RVC/RGC framework, and, as explained above, includes the BSD and the FND. Further, the decoder description information includes an abstract decoder model which indicates description information for a VTL and a GTL, FUs corresponding to the VTL and the GTL, that is, the decoding units, and the decoders 130, 150 and 170. Moreover, the decoder description information includes decoder implementation into a hardware/software type based on the abstract decoder model, that is, decoder implementation which indicates a codec realization procedure.

The decoders 130, 150 and 170 receive input data corresponding to them among the data outputted from the parser 110, that is, the token A, the token B, the token C and the token D, and execute the decoding algorithms. Speaking in detail, when the token A and the token B are inputted as input data, the decoder 1 130 executes the decoding algorithm realized therein and outputs the token E as output data. Also, when the token A and the token D are inputted as input data, the decoder 2 150 executes the decoding algorithm realized therein and outputs the token F as output data. Further, when the token A, the token C, the token E and the token F are inputted as input data, the decoder 3 170 executes the decoding algorithm realized therein and outputs finally decoded multimedia data. As a consequence, multimedia data for providing a multimedia service such as audio, video and the like to users are outputted.

As examples of the tokens, that is, the input data inputted to the decoders 130, 150 and 170, the token A includes information data for initializing the execution of the decoding algorithms of the decoders 130, 150 and 170 for frames of the multimedia data when executing the decoding algorithms of the decoders 130, 150 and 170, for example, frame coding information data (FCODE) and frame length information data (WIDTH). Further, the token B, the token C and the token D include motion vector information data encoded in the multimedia data, and additional information data necessary for decoding of the motion vector information data. For example, the motion vector information data includes motion vector data (MOTION) and motion vector difference data (MVD), and the additional information data includes mode data (VOPMODE) and additional motion vector data (FOUR_MV). Moreover, the token E and the token F include direction information data for prediction decoding of a motion vector in the multimedia data according to the decoding of the token B and the token D, for example, coordinate data (COORDINATE) including directional values of a left direction, an upward direction, a left upward direction, etc.

In order to ensure that the decoders 130, 150 and 170 normally execute the decoding algorithms realized therein and precisely decode the multimedia data as described above, the input data, that is, the tokens, corresponding to the decoders 130, 150 and 170, should be precisely inputted at precise times (or in a precise sequence). Therefore, in order to allow the decoders 130, 150 and 170 to normally execute the decoding algorithms, that is, in order to normally decode the large-capacity multimedia data through the decoders 130, 150 and 170 as the plurality of decoding units, the schedulers 120, 140 and 160 are provided in the present embodiment of the invention.

The schedulers 120, 140 and 160 schedule that the input data, that is, the tokens, to be inputted to the decoders 130, 150 and 170 are precisely inputted to the corresponding decoders 130, 150 and 170 at the precise times (or in the precise sequence) for normal decoding. The schedulers 120, 140 and 160 schedule the tokens to be inputted to the decoders 130, 150 and 170 in consideration of the connection relationships of the decoders 130, 150 and 170, that is, the FND, and the bitstream structure of the multimedia data to be decoded by the decoders 130, 150 and 170, that is, the BSD.

Namely, the schedulers 120, 140 and 160 check the connection relationships of the decoders 130, 150 and 170 through the FND, check the input and output relationships of the decoders 130, 150 and 170 from the connection relationships of the decoders 130, 150 and 170, that is, data transmission among the decoders 130, 150 and 170, that is, the respective FUs, and schedule the tokens such that normal decoding of the multimedia data is implemented through the decoders 130, 150 and 170. For example, the scheduler 3 160 checks the connection relationships of the decoders 130, 150 and 170 through the FND, and schedules the output data of the decoder 1 130 and the decoder 2 150, that is, the token E and the token F, as the input data to the decoder 3 170. Also, the schedulers 120, 140 and 160 check the bitstream structure of the multimedia data through the BSD, that is, the tokens outputted from the parser 110, and schedule the tokens so that the normal decoding of the multimedia data is implemented through the decoders 130, 150 and 170.

Further, the schedulers 120, 140 and 160 schedule the tokens to be inputted to the decoders 130, 150 and 170 in consideration of the capability information of the decoders 130, 150 and 170, for example, the information of the decoding algorithms realized in the decoders 130, 150 and 170, information regarding the input data necessary for the execution of the decoding algorithms of the decoders 130, 150 and 170 according to the decoding algorithms, that is, the information of the input tokens, and the information of the capabilities of the decoders 130, 150 and 170 for executing the decoding algorithms. That is, the capability information of the decoders 130, 150 and 170 includes the decoding algorithm information, the input token information and the decoding algorithm execution capability information. The decoding algorithm execution capability information includes information regarding an amount of data to be processed, a processing speed, etc. when executing the decoding algorithms by the decoders 130, 150 and 170. For example, the schedulers 120, 140 and 160 schedule the tokens to be precisely inputted to the respective decoders 130, 150 and 170 for the normal execution of the decoding algorithms of the respective decoders 130, 150 and 170, and the precise input times (or the precise input sequence) of the tokens, in consideration of the BSD and the capability information of the decoders 130, 150 and 170.

That is to say, the schedulers 120, 140 and 160 schedule the tokens to be inputted to the decoders 130, 150 and 170 as described above, using token scheduling information. The token scheduling information is included in the decoder description information, and includes the FND, the BSD and the capability information of the decoders 130, 150 and 170. In other words, the schedulers 120, 140 and 160 perform scheduling by using the FND, the BSD and the capability information of the decoders 130, 150 and 170, as the token scheduling information included in the decoder description information. When the decoders 130, 150 and 170 are initially realized in the system, the token scheduling information is acquired from the decoders 130, 150 and 170.

The token scheduling information may further include the data characteristic information of the plurality of tokens analyzed by the parser 110, and the schedulers 120, 140 and 160 schedule the plurality of tokens in consideration of the data characteristic information and input the plurality of tokens to the respective decoders 130, 150 and 170 at the precise times (or in the precise sequence). For example, the schedulers 120, 140 and 160 schedule the token A using the data characteristic information such that the information data for initializing the execution of the decoding algorithms for each frame of the multimedia data, that is, the token A is inputted to the respective decoders 130, 150 and 170 at a frame start time of the multimedia data. Through such scheduling by the schedulers 120, 140 and 160 in consideration of the data characteristic information, the token A is inputted to the respective decoders 130, 150 and 170 only at the frame start time.

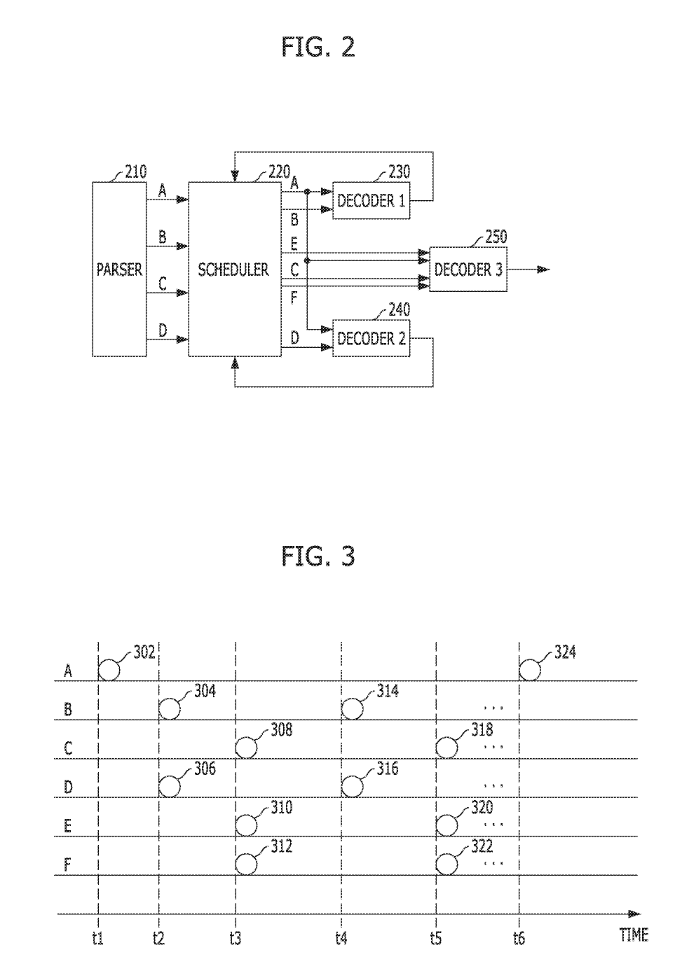

Thus, the scheduler 1 120 schedules the input data, that is, tokens, necessary for the normal execution of the decoding algorithm of the decoder 1 130 among the tokens outputted from the parser 110, and accordingly, precisely inputs the token A and the token B to the decoder 1 130 at precise times (or in a precise sequence). The scheduler 2 140 schedules the input data, that is, tokens, necessary for the normal execution of the decoding algorithm of the decoder 2 150 among the tokens outputted from the parser 110, and accordingly, precisely inputs the token A and the token D to the decoder 2 150 at precise times (or in a precise sequence). Further, the scheduler 3 160 schedules the input data, that is, tokens, necessary for the normal execution of the decoding algorithm of the decoder 3 170 among the tokens outputted from the parser 110 and the tokens outputted from the decoder 1 130 and the decoder 2 150, and accordingly, precisely inputs the token A, the token C, the token E and the token F to the decoder 3 170 at precise times (or in a precise sequence). Since the input and output of the tokens to the decoders 130, 150 and 170 according to the scheduling of the schedulers 120, 140 and 160 will be concretely described later with reference to FIG. 3, detailed description thereof will be omitted herein. Hereinbelow, an apparatus for receiving data in a communication system in accordance with another embodiment of the present invention will be described in detail with reference to FIG. 2.

FIG. 2 is a diagram schematically showing the configuration of an apparatus for receiving data in a communication system in accordance with another embodiment of the present invention. FIG. 2 is a drawing schematically showing the configuration of a data reception apparatus for receiving and decoding large-capacity multimedia data such as audio, video and the like in a communication system, for example, an MPEG-based network codec system, in accordance with another embodiment of the present invention. Specifically, while FIG. 1 schematically shows the configuration in which schedulers are provided to respectively correspond to the decoding units as the plurality of FUs, FIG. 2 schematically shows the configuration in which a single scheduler is provided for decoding units as a plurality of FUs.

Referring to FIG. 2, the data reception apparatus includes a parser 210 configured to receive large-capacity multimedia data such as audio, video and the like, decoders, for example, a decoder 1 230, a decoder 2 240 and a decoder 3 250, configured to decode the large-capacity multimedia data, and a scheduler 220 configured to schedule the multimedia data to be inputted to the decoders 230, 240 and 250 to be decoded.

As described above with reference to FIG. 1, the parser 210 receives the large-capacity multimedia data which are encoded and transmitted by a transmission apparatus of the communication system, and analyzes the encoded bitstreams of the received multimedia data into individual data capable of being processed by the respective decoders 230, 240 and 250, for example, into tokens. Here, the parser 210 is realized by one or more syntax parser FUs as one or more exemplary FUs for analyzing the bitstreams of the received multimedia data and outputting a plurality of tokens. The syntax parser FUs may be provided as already completed FUs like other FUs, for example, decoding units, or may be provided when actually realizing a codec system based on BSD (bitstream syntax description) information. Since the BSD is explained above in detail, detailed explanation thereof will be omitted herein.

The tokens mean data which are to be inputted to the decoders 230, 240 and 250 to allow the decoders 230, 240 and 250 to decode the large-capacity multimedia data, so as to receive data by decoding the large-capacity multimedia data through a plurality of decoding units as the plurality of FUs having predetermined decoding algorithms realized therein, that is, the decoders 230, 240 and 250. Input data, that is, input tokens are inputted to the decoders 230, 240 and 250 so that decoding can be normally implemented according to the decoding algorithms of the respective decoders 230, 240 and 250.

Also, after analyzing the encoded bitstreams of the received multimedia data into the tokens as the individual data capable of being processed by the respective decoders 230, 240 and 250, the parser 210 outputs the respective analyzed tokens, for example, a token A, a token B, a token C and a token D. The token A, the token B, the token C and the token D are outputted independently of one another according to the data processing capability of the parser 210.

As described above with reference to FIG. 1, the decoders 230, 240 and 250 serve as FUs being information processing modules having the predetermined decoding algorithms realized therein, that is, as decoding units. When input data necessary for the execution of the decoding algorithms realized in the respective decoders 230, 240 and 250, that is, the tokens corresponding to the respective decoders 230, 240 and 250 are respectively inputted, the decoders 230, 240 and 250 execute the decoding algorithms and decode the large-capacity multimedia data.

Similar to the decoders 130, 150 and 170 explained above with reference to FIG. 1, the decoders 230, 240 and 250 receive the input data corresponding to them among the data outputted from the parser 210, that is, the token A, the token B, the token C and the token D, and execute the decoding algorithms. Speaking in detail, when the token A and the token B are inputted as input data, the decoder 1 230 executes the decoding algorithm realized therein and outputs the token E as output data. Also, when the token A and the token D are inputted as input data, the decoder 2 240 executes the decoding algorithm realized therein and outputs the token F as output data. Further, when the token A, the token C, the token E and the token F are inputted as input data, the decoder 3 250 executes the decoding algorithm realized therein and outputs finally decoded multimedia data. As a consequence, multimedia data for providing a multimedia service such as audio, video and the like to users are outputted. Since examples of the tokens, that is, examples of the input data to be inputted to the respective decoders 230, 240 and 250 are explained above, detailed descriptions thereof will be omitted herein.

In order to ensure that the decoders 230, 240 and 250 normally execute the decoding algorithms realized therein and precisely decode the multimedia data as described above, the input data, that is, the tokens, corresponding to the decoders 230, 240 and 250, should be precisely inputted at precise times (or in a precise sequence). Therefore, in order to allow the decoders 230, 240 and 250 to normally execute the decoding algorithms, that is, in order to normally decode the large-capacity multimedia data through the decoders 230, 240 and 250 as the plurality of decoding units, the single scheduler 220 is provided in the present embodiment of the invention.

The scheduler 220 schedules that the input data, that is, the tokens, to be inputted to the decoders 230, 240 and 250 are precisely inputted to the corresponding decoders 230, 240 and 250 at the precise times (or in the precise sequence) for normal decoding. The scheduler 220 schedules the tokens to be inputted to the decoders 230, 240 and 250 in consideration of the connection relationships of the decoders 230, 240 and 250, that is, the FND, and the bitstream structure of the multimedia data to be decoded by the decoders 230, 240 and 250, that is, the BSD.

Namely, the scheduler 220 checks the connection relationships of the decoders 230, 240 and 250 through the FND, checks the input and output relationships of the decoders 230, 240 and 250 from the connection relationships of the decoders 230, 240 and 250, that is, data transmission among the decoders 230, 240 and 250, that is, the respective FUs, and schedules the tokens such that normal decoding of the multimedia data is implemented through the decoders 230, 240 and 250. For example, the scheduler 220 checks the connection relationships of the decoders 230, 240 and 250 through the FND, and schedules the output data of the decoder 1 230 and the decoder 2 240, that is, the token E and the token F, as the input data to the decoder 3 250. Also, the scheduler 220 checks the bitstream structure of the multimedia data through the BSD, that is, the tokens outputted from the parser 210, and schedule the tokens such that the normal decoding of the multimedia data is implemented through the decoders 230, 240 and 250.

Further, the scheduler 220 schedules the tokens to be inputted to the decoders 230, 240 and 250 in consideration of the capability information of the decoders 230, 240 and 250, for example, the information of the decoding algorithms realized in the decoders 230, 240 and 250, information regarding the input data necessary for the execution of the decoding algorithms of the decoders 230, 240 and 250 according to the decoding algorithms, that is, the information of the input tokens, and the information of the capabilities of the decoders 230, 240 and 250 for executing the decoding algorithms. That is, the capability information of the decoders 230, 240 and 250 includes the decoding algorithm information, the input token information and the decoding algorithm execution capability information. The decoding algorithm execution capability information includes information regarding an amount of data to be processed, a processing speed, etc. when executing the decoding algorithms by the decoders 230, 240 and 250. For example, the scheduler 220 schedules the tokens to be precisely inputted to the respective decoders 230, 240 and 250 for the normal execution of the decoding algorithms of the respective decoders 230, 240 and 250, and the precise input times (or the precise input sequence) of the tokens, in consideration of the BSD and the capability information of the decoders 230, 240 and 250.

That is to say, the scheduler 220 schedules the tokens to be inputted to the decoders 230, 240 and 250 as described above, using token scheduling information. The token scheduling information is included in the decoder description information, and includes the FND, the BSD and the capability information of the decoders 230, 240 and 250. In other words, the scheduler 220 performs scheduling by using the FND, the BSD and the capability information of the decoders 230, 240 and 250, as the token scheduling information included in the decoder description information. When the decoders 230, 240 and 250 are initially realized in the system, the token scheduling information is acquired from the decoders 230, 240 and 250.

The token scheduling information may further include the data characteristic information of the plurality of tokens analyzed by the parser 210, and the scheduler 220 schedules the plurality of tokens in consideration of the data characteristic information, and inputs the plurality of tokens to the respective decoders 230, 240 and 250 at the precise times (or in the precise sequence). For example, the scheduler 220 schedules the token A using the data characteristic information such that the information data for initializing the execution of the decoding algorithms for each frame of the multimedia data, that is, the token A is inputted to the respective decoders 230, 240 and 250 at a frame start time of the multimedia data. Through such scheduling by the scheduler 220 in consideration of the data characteristic information, the token A is inputted to the respective decoders 230, 240 and 250 only at the frame start time.

Therefore, the scheduler 220 schedules the input data, that is, the tokens, necessary for the normal execution of the decoding algorithm of the decoder 1 230 among the tokens outputted from the parser 210, and accordingly, precisely inputs the token A and the token B to the decoder 1 230 at precise times (or in a precise sequence). The scheduler 220 schedules the input data, that is, the tokens, necessary for the normal execution of the decoding algorithm of the decoder 2 240 among the tokens outputted from the parser 210, and accordingly, precisely inputs the token A and the token D to the decoder 2 240 at precise times (or in a precise sequence). Further, the scheduler 220 schedules the input data, that is, the tokens, necessary for the normal execution of the decoding algorithm of the decoder 3 250 among the tokens outputted from the parser 210 and the tokens outputted from the decoder 1 230 and the decoder 2 240, and accordingly, precisely inputs the token A, the token C, the token E and the token F to the decoder 3 250 at precise times (or in a precise sequence). Hereinbelow, the input and output of the tokens to the decoders 130, 150, 170, 230, 240 and 250 according to the scheduling of the schedulers 120, 140, 160 and 220 explained above with reference to FIGS. 1 and 2 will be concretely described with reference to FIG. 3.

FIG. 3 is a diagram explaining input and output of tokens in the apparatuses for receiving data in a communication system in accordance with the embodiments of the present invention.

Referring to FIG. 3, as explained above with reference to FIGS. 1 and 2, the data reception apparatus analyzes the encoded bitstreams of the multimedia data received by the parser into individual data capable of being processed by the respective decoders, for example, into tokens, and outputs the respective analyzed tokens. That is to say, the parser outputs the token A, the token B, the token C and the token D independently of one another. Then, in order to receive data through decoding the received multimedia data using the plurality of decoding units, the data reception apparatus schedules the tokens outputted from the parser, for example, the token A, the token B, the token C and the token D, using the token scheduling information, and schedules the tokens outputted from the decoding units, for example, the token E and the token F.

For example, describing concretely the operations of the data reception apparatus on the time axis, first, as the parser analyzes the encoded bitstreams of the received multimedia data and independently outputs the plurality of tokens according to the data processing capability thereof, the scheduler schedules initializing information data for initializing the plurality of decoding units, that is, the token A 302 and inputs the token A 302 to the plurality of decoding units at a time t1, to decode the data of an optional n^{th} frame t1 to t6 from the multimedia data. In other words, through such scheduling, the token A 302 is inputted to the plurality of decoding units at the time t1, and accordingly, the plurality of decoding units are initialized. After the plurality of decoding units are initialized in this way, the scheduler performs a scheduling operation to prevent the token A outputted from the parser from being inputted again to the plurality of decoding units during the n^{th} frame.

Then, the scheduler schedules the token B 304 and inputs the token B 304 to the decoder 1 130 or 230 at a time t2 such that an optional decoding unit among the plurality of decoding units, for example, the decoder 1 130 or 230 can normally execute the decoding algorithm, and schedules the token D 306 and inputs the token D 306 to the decoder 2 150 or 240 at the time t2 such that the decoder 2 150 or 240 can normally execute the decoding algorithm. Namely, through such scheduling, the token B 304 and the token D 306 are respectively inputted to the decoder 1 130 or 230 and the decoder 2 150 or 240 at the time t2, and accordingly, the decoders 130 or 230 and 150 or 240 decode the token B 304 and the token D 306 by normally executing the predetermined decoding algorithms and output the token

E and the token F.

Also, the scheduler schedules the token C 308, the token E 310 and the token F 312 and inputs the token C 308, the token E 310 and the token F 312 to the decoder 3 170 or 250 at a time t3 such that an optional decoding unit among the plurality of decoding units, for example, the decoder 3 170 or 250 can normally execute the decoding algorithm. Namely, through such scheduling, the token C 308, the token E 310 and the token F 312 are respectively inputted to the decoder 3 170 or 250 at the time t3, and accordingly, the decoder 3 170 or 250 decodes the token C 308, the token E 310 and the token F 312 by normally executing the predetermined decoding algorithm and outputs finally decoded partial multimedia data for a specified time interval of the n^{th} frame.

Next, since the decoding of the n^{th} frame of the multimedia data is not completed, the scheduler schedules the token B 314 and inputs the token B 314 to the decoder 1 130 or 230 at a time t4 such that an optional decoding unit of the plurality of decoding units, for example, the decoder 1 130 or 230 can normally execute the decoding algorithm, and schedules the token D 316 and inputs the token D to the decoder 2 150 or 240 such that the decoder 2 150 or 240 can normally execute the decoding algorithm. Namely, through such scheduling, the token B 314 and the token D 316 are respectively inputted to the decoder 1 130 or 230 and the decoder 150 or 240 at the time t4, and accordingly, the decoders 130 or 230 and 150 or 240 decode the token B 314 and the token D 316 by normally executing the predetermined decoding algorithms and output the token E and the token F.

Further, the scheduler schedules the token C 318, the token E 320 and the token F 322 and inputs the token C 318, the token E 320 and the token F 322 to the decoder 3 170 or 250 at a time t5 such that an optional decoding unit among the plurality of decoding units, for example, the decoder 3 170 or 250 can normally execute the decoding algorithm. Namely, through such scheduling, the token C 318, the token E 320 and the token F 322 are respectively inputted to the decoder 3 170 or 250 at the time t5, and accordingly, the decoder 3 170 or 250 decodes the token C 318, the token E 320 and the token F 322 by normally executing the predetermined decoding algorithm and outputs finally decoded partial multimedia data for a specified time interval of the n^{th} frame.

If the n^{th} frame of the finally decoded multimedia data is outputted through decoding by the plurality of decoding units according to the scheduling, the scheduler schedules initializing information data for initializing the plurality of decoding units, that is, the token A 324 and inputs the token A 324 to the plurality of decoding units at a time t6, to decode the data of a next frame, for example, an (n+1)^{th} frame. In other words, through such scheduling, the token A 324 is inputted to the plurality of decoding units at the time t6, and accordingly, the plurality of decoding units are initialized. After the plurality of decoding units are initialized in this way, the scheduler performs a scheduling operation as described above for the tokens and outputs the (n+1)^{th} frame of the finally decoded multimedia data.

In this way, in the apparatus for receiving data in a communication system in accordance with the embodiments of the present invention, since the plurality of tokens are scheduled with respect to the large-capacity multimedia data such as audio, video and the like by using the token scheduling information, data can be received at a high speed and stably by normally decoding the large-capacity multimedia data through the plurality of decoding units. In particular, in the case where all the input data, that is, the tokens, necessary for the execution of the decoding algorithms exist, the data reception apparatus schedules the tokens and inputs the tokens to corresponding decoding units at precise times (or in a precise sequence), so that the predetermined decoding algorithms realized in the plurality of decoding units can be normally executed.

Further, the data reception apparatus checks the token scheduling information, for example, the FND, and confirms decoding units which should execute decoding algorithms with priority. That is to say, the data reception apparatus checks the decoding priority of the plurality of decoding units, and schedules the tokens in conformity with the decoding prioirty. Tokens are inputted earlier to decoding units with priority, for example, the decoder 1 130 or 230 and the decoder 2 150 or 240 than the decoder 3 170 or 250.

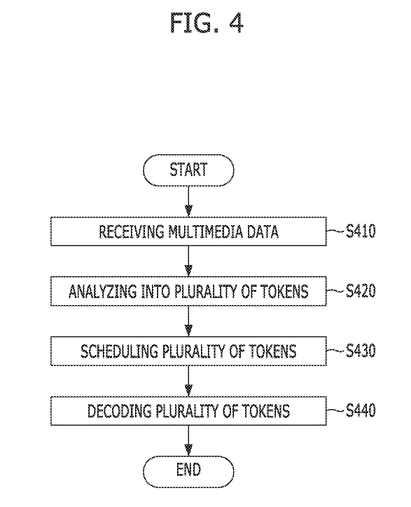

The data reception apparatus schedules the tokens through the single scheduler as shown in FIG. 2, or schedules the tokens through scheduling units respectively corresponding to the plurality of decoding units as shown in FIG. 1. In other words, the data reception apparatus schedules the tokens through at least one scheduler and precisely inputs the input tokens corresponding to the respective decoding units at precise times (or in a precise sequence) to the plurality of decoding units. Hereinbelow, reception of the multimedia data by the data reception apparatus in a communication system in accordance with the embodiments of the present invention will be concretely described with reference to FIG. 4.

FIG. 4 is a flow chart schematically explaining operations of the apparatus for receiving data in a communication system in accordance with the embodiment of the present invention.

Referring to FIG. 4, in step S410, the data reception apparatus receives large-capacity multimedia data such as audio, video and the like. Then, in step S420, the encoded bitstreams of the received multimedia data are analyzed into individual data capable of being processed by the plurality of decoding units, for example, into tokens. Since the tokens are concretely explained above, detailed descriptions thereof will be omitted herein.

Next, in step 430, the analyzed tokens are scheduled using token scheduling information such that the plurality of decoding units can normally execute the predetermined decoding algorithms and can precisely decode the multimedia data. The token scheduling information is included in the decoder description information, and includes the FND, the BSD and the capability information of the decoders 130, 150 and 170. Through such scheduling of the tokens, corresponding tokens necessary for normal execution of the predetermined decoding algorithms are precisely inputted to the plurality of decoding units at precise times (or in a precise sequence). Since the scheduling of the tokens is concretely explained above, detailed description thereof will be omitted herein.

Then, in step 440, as the corresponding input data, that is, the tokens, are precisely inputted to the respective decoding units at the precise times (or in the precise sequence) through scheduling of the tokens, the respective decoding units normally execute the predetermined decoding algorithms realized therein and thereby decode the inputted tokens, and accordingly, outputs finally decoded multimedia data and provide a multimedia service such as audio, video and the like.

As is apparent from the above descriptions, in the embodiments of the present invention, large-capacity multimedia data such as audio, video and the like are precisely scheduled to a plurality of decoding units having predetermined decoding algorithms realized therein in a communication system, and corresponding input data are precisely inputted at precise times (or in a precise sequence) to the plurality of decoding units having the predetermined decoding algorithms realized therein, by which the large-capacity multimedia data can be normally decoded through the plurality of decoding units having the predetermined decoding algorithms realized therein. As a consequence, in the embodiments of the present invention, large-capacity multimedia data such as audio, video and the like can be received at a high speed and stably.

Furthermore, in the embodiments of the present invention, due to the fact that the large-capacity multimedia data are scheduled with respect to the plurality of decoding units having the predetermined decoding algorithms respectively realized therein, that is, the corresponding input data to be inputted to the plurality of decoding units are scheduled, the plurality of decoding units can normally decode the large-capacity multimedia data. In particular, since independent decoding operations of the respective decoding units are possible through scheduling of the corresponding input data, the predetermined decoding algorithms can be adaptively executed and data can be normally decoded in other communication systems.

While the present invention has been described with respect to the specific embodiments, it will be apparent to those skilled in the art that various changes and modifications may be made without departing from the spirit and scope of the invention as defined in the following claims.

What is claimed is:

1. An apparatus for receiving data in a communication system, comprising:
a parser configured to receive multimedia data and analyze the multimedia data into a plurality of tokens;
a plurality of decoding units configured to receive input tokens corresponding to them among the plurality of tokens and decode the multimedia data; and
a scheduler configured to schedule the plurality of tokens and transmit the respective input tokens to the plurality of decoding units at precise times,
wherein the plurality of decoding units decode the multimedia data by the input tokens transmitted from the scheduler and provide a multimedia service.

2. The apparatus of claim 1,
wherein the scheduler comprises a plurality of scheduling units which respectively correspond to the plurality of decoding units, and
wherein the scheduler and the plurality of scheduling units schedule the plurality of tokens using token scheduling information.

3. The apparatus of claim 2, wherein the token scheduling information comprises FND (FU (functional unit) network description) information of the plurality of decoding units, BSD (bitstream syntax description) information of the multimedia data, and capability information of the plurality of decoding units.

4. The apparatus of claim 3, wherein the scheduler and the plurality of scheduling units check input and output relationships of the plurality of decoding units from the FND information, perform scheduling according to the input and output relationships, and transmit an output token of a first decoding unit among the plurality of decoding units as an input token of a second decoding unit.

5. The apparatus of claim 3, wherein the scheduler and the plurality of scheduling units check a decoding priority of the plurality of decoding units through the FND information, schedule the plurality of tokens in conformity with the decoding priority, and transmit the input tokens at precise times through such scheduling.

6. The apparatus of claim 3, wherein the scheduler and the plurality of scheduling units perform scheduling by checking the plurality of tokens analyzed by the parser from the BSD of the multimedia data, and transmit the input tokens necessary for normal decoding by the plurality of decoding units at precise times through such scheduling.

7. The apparatus of claim 3, wherein the capability information of the plurality of decoding units comprises information of decoding algorithms respectively realized in the plurality of decoding units, information of the input tokens, and execution capability information of the decoding algorithms.

8. The apparatus of claim 7, wherein the execution capability information of the decoding algorithms comprises information regarding an amount of data to be processed and a processing speed upon decoding by the plurality of decoding units.

9. The apparatus of claim 7, wherein the scheduler and the plurality of scheduling units check and schedule the input tokens necessary for decoding by the plurality of decoding units from the capability information of the plurality of decoding units, and transmit the respective input tokens at precise times through such scheduling.

10. The apparatus of claim 2, wherein the scheduler and the plurality of scheduling units schedule the input tokens and transmit the respective input tokens at precise times when all the input tokens necessary for decoding by the plurality of decoding units exist.

11. The apparatus of claim 2,
wherein the token scheduling information comprises data characteristic information of the plurality of tokens, and
wherein the scheduler and the plurality of scheduling units check characteristics of the plurality of tokens from the data characteristic information, schedule the plurality of tokens according to the characteristics of the plurality of tokens, and transmit the respective input tokens at precise times through such scheduling.

12. The apparatus of claim 1, wherein the parser parses encoded bitstreams of the multimedia data, and analyzes the multimedia data into the plurality of tokens as individual data capable of being processed by the plurality of decoding units.

13. A method for receiving data in a communication system, comprising:
receiving multimedia data, parsing encoded bitstreams of the multimedia data, and analyzing the multimedia data into a plurality of tokens;
scheduling the plurality of tokens into respective input tokens corresponding to predetermined decoding algorithms; and
executing the respective predetermined decoding algorithms for the input tokens and decoding the multimedia data,
wherein, in the scheduling, the respective input tokens are inputted at precise times to the predetermined decoding algorithms respectively corresponding to the input tokens.

14. The method of claim 13, wherein, in said scheduling, input and output relationships of a plurality units having the predetermined decoding algorithms respectively realized therein are checked from FND (FU (functional unit) network description) information of the plurality of units, scheduling is performed according to the input and output relationships, and an output token of a first unit among the plurality of units is inputted as an input token of a second unit.

15. The method of claim 14, wherein, in said scheduling, a decoding priority of the predetermined decoding algorithms is checked through the FND information, the plurality of tokens are scheduled in conformity with the decoding priority, and the input tokens are respectively inputted at precise times.

16. The method of claim 13, wherein, in said scheduling, the plurality of analyzed tokens are checked from BSD (bitstream syntax description) information of the multimedia data, the plurality of tokens are scheduled, and the input tokens necessary for normal execution of the predetermined decoding algorithms are respectively inputted at precise times.

17. The method of claim 13, wherein, in said scheduling, the input tokens necessary for normal execution of the predetermined decoding algorithms are checked from capability information of the plurality of units having the predetermined decoding algorithms respectively realized therein, and the input tokens are respectively inputted at precise times.

18. The method of claim 17,
wherein the capability information of the plurality of units comprises information of the decoding algorithms, information of the input tokens, and execution capability information of the decoding algorithms, and
wherein the execution capability information of the decoding algorithms comprises information regarding an amount of data to be processed and a processing speed upon decoding by the plurality of units.

19. The method of claim 13, wherein, in said scheduling, when all the input tokens necessary for execution of the predetermined decoding algorithms exist, the input tokens are scheduled and are respectively inputted at precise times.

20. The method of claim 13, wherein, in said scheduling, characteristics of the plurality of tokens are checked from data characteristic information of the plurality of tokens, the plurality of tokens are scheduled according to the characteristics of the plurality of tokens, and the input tokens are respectively inputted at precise times.
